(19) United States
(12) Patent Application Publication
(10) Pub. No.: US 2002/0071278 A1
(43) Pub. Date: Jun. 13, 2002

(54) Revolving stage light

(75) Inventor: Yu-Chuan Lin, Taipei Hsien (TW)

Correspondence Address: Dougherty & Troxell, ONE SKYLINE PLACE, 5205 LEESBURG PIKE, SUITE 1404, FALLS CHURCH, VA, 22041, US

(73) Assignee: SUPERSTAR LIGHTING COMPANY LIMITED

(21) Appl. No.: 09/788,382

(22) Filed: Feb. 21, 2001

(30) Foreign Application Priority Data
Dec. 13, 2000 (TW) 89221596

(51) Int. Cl. F21V 1/00; F21V 9/00

(52) U.S. Cl. 362/287; 362/250; 362/418

(57) ABSTRACT

A revolving stage light includes a drive unit supported on a stand, a fixed power contact unit provided at a front side of the drive unit, a revolving power contact unit coupled to an output shaft of the drive unit and turned with the output shaft relative to the fixed power contact unit, a revolving lamp wheel rotated with the revolving power contact unit, the revolving lamp wheel having different colors of lamp bulbs disposed around the periphery that obtain electricity from a power cable through the fixed power contact unit via the revolving power contact unit.

### BACKGROUND OF THE INVENTION

1. Field of The Invention

The present invention relates to a stage light and, more particularly, to a revolving stage light.

2. Description of Related Art

The development of lighting on a stage becomes getting complicated due to the performing arts being getting compact. Generally, the lighting accompanying with changeable sound can enhance the air on the stage such that the performance on the stage can be brought into a climax accordingly. Therefore, the lighting design is an extremely important part especially in designing a stage.

However, it is known that a single rotating light on a stage is not possible to create a cheering mood such that the air on the stage can not be controlled very well. That is why lighting devices have to be mounted at the ceiling above the stage, attached to the wall nearby the stage, and laid on the stage. Hence, it appears a phenomenon that there are a lot of lights around the area of a stage. But, too many lights around a stage not only break the integral beauty sense of the stage but also occupy too much space around the stage such that the area for performing a play becomes less substantially. Moreover, it has to be mentioned that to fix so many lights for the stage is really a tedious job.

Lighting and sound effects greatly promote the atmosphere at the stage. The stage light arrangement is important in stage design. In order to produce attractive lighting effect, different stage lights including overhead lighting battens, cyclorama floodlights, spot bar lamps, footlights, and the like may be used. In order to safe floor space, revolving stage lights may be used instead of conventional footlights. Taiwan Utility Model No. 117361 (Filing No. 85208392), issued to the present invention, discloses a revolving stage light transmission mechanism, which uses a motor to rotate a revolving shaft, causing link means to rotate two spherical lamps horizontally. This design further comprises a revolving power contact unit, which enables the power cable to be rotated with the transmission shaft, preventing a tangle. During horizontal rotation of each spherical lamp, a disk-like gear wheel is rotated along the periphery of an annular gear. By means of this arrangement, only one motor is sufficient to rotate the stage light in the transverse direction and the longitudinal direction. However, the revolving action of this design of stage light is a horizontal gyration that is less attractive.

### SUMMARY OF THE INVENTION

The present invention has been accomplished to provide a revolving stage light It is the main object of the present invention to provide a stage light, which rotates a set of different colors of lamps around a horizontal axis when electrically connected. According to one aspect of the present invention, the revolving stage light comprises a drive unit supported on a stand, a fixed power contact unit provided at a front side of the drive unit, a revolving power contact unit coupled to an output shaft of the drive unit and turned with the output shaft relative to the fixed power contact unit, a revolving lamp wheel rotated with the revolving power contact unit, the revolving lamp wheel having different colors of lamp bulbs disposed around the periphery that obtain electricity from a power cable through the fixed power contact unit via the revolving power contact unit. According to another aspect of the present invention, a refractor is provided at the front side of the front side of the revolving lamp wheel to refract light in different directions.

### BRIEF DESCRIPTION OF THE DRAWINGS

The present invention can be more fully understood by referring to the following description and accompanying drawing, in which:

FIG. 1 is an exploded view of a part of the preferred embodiment of the present invention, showing the structure of the drive unit and the fixed power contact unit;

FIG. 2 is an exploded view of a part of the preferred embodiment of the present invention, showing the structure of the revolving power contact unit, the revolving lamp wheel, and the refractor;

FIG. 3 is a top view in section of the preferred embodiment of the present invention; and

FIG. 4 is an elevational view of the preferred embodiment of the present invention.

### DETAILED DESCRIPTION OF THE PREFERRED EMBODIMENTS

Referring to FIGS. from 1 through 4, a revolving stage light in accordance with the present invention is generally comprised of a drive unit 1, a fixed power contact unit 2, a revolving power contact unit 3, a revolving lamp wheel 4, and a refractor 5.

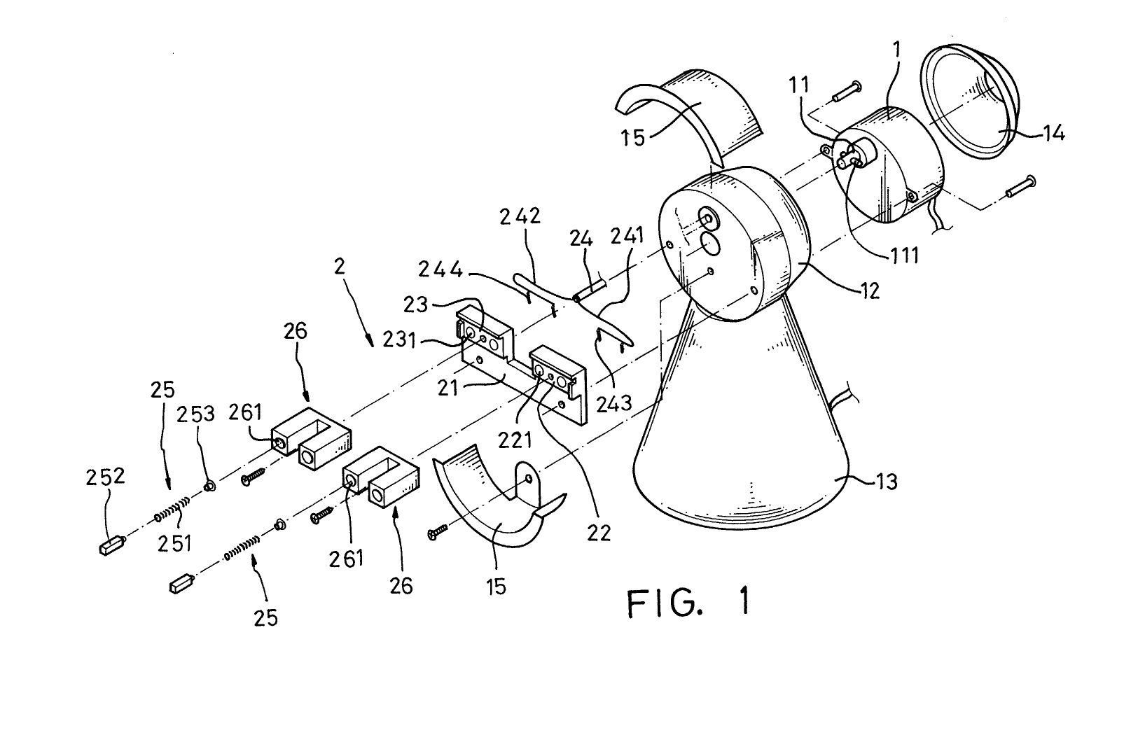

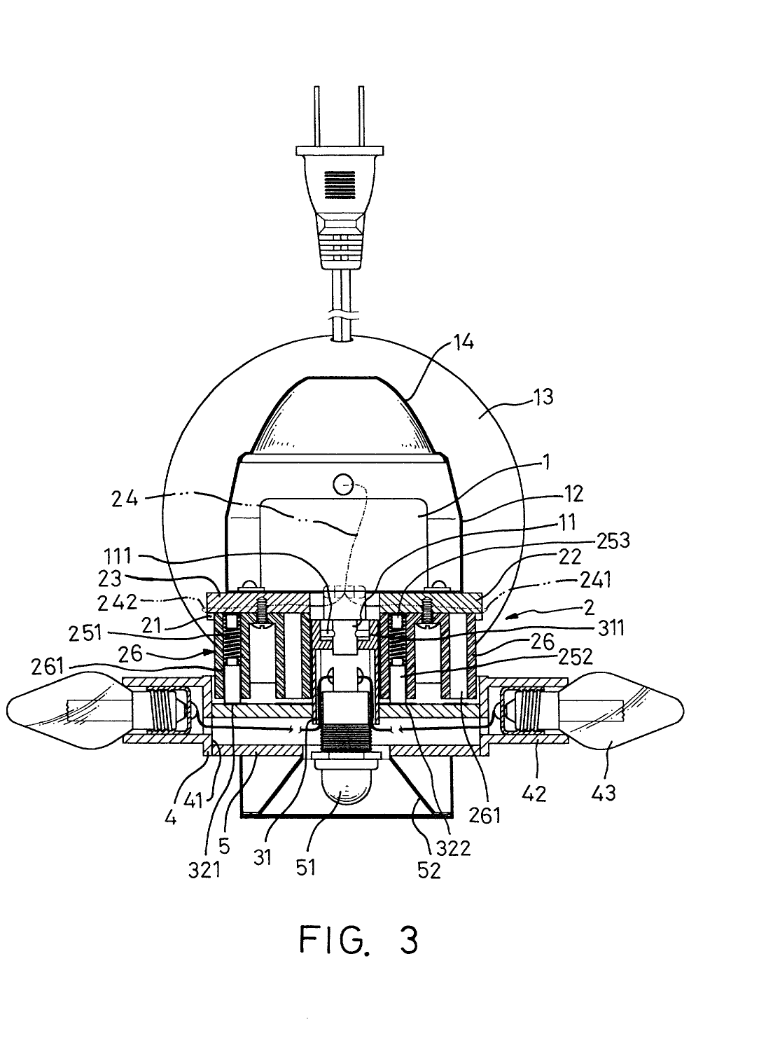

Referring to FIGS. 1 and 3, the drive unit I according to the present preferred embodiment is a motor mounted in a motor case 12, having an output shaft 11. The output shaft 11 comprises a coupling rod 111 extended sideways from the periphery.

The fixed power contact unit 2 is provided at the front side of the motor case 12, comprising a base frame 21, a power cable 24, two metal contact terminal devices 25, and two locating blocks 26. The base frame 21 comprises two seats 22 and 23. The seats 22 and 23 each have at least one locating groove, for example, two locating grooves 221 or 231. The power cable 24 has two wires 241 and 242 respectively fastened to the seats 22 and 23 of the base frame 21. The wires 241 and 242 each has at least one terminal, for example, two terminals 243 or 244 respectively installed in the locating grooves 221 and 231 of the seats 22 and 23 of the base frame 21. The locating blocks 26 are respectively fixedly fastened to the seats 22 and 23 of the base frame 21, each having at least one, for example, two through holes 261 respectively aimed at the terminals 243 and 244 of the wires 241 and 242 of the power cable 24. The metal contact terminal devices 25 are selectively mounted in one through hole 261 of each locating block 26 and maintained in contact with one terminal 243 or 244 of each of the wires 241 and 242. Each metal contact terminal device 25 comprises a metal retainer 253 mounted in one through hole 261 of one of the locating blocks 26 and constantly maintained in contact with one terminal 243 or 244 of one wire 241 or 242 of the power cable 24, a metal compression spring 251 mounted in one through hole 261 of one of the locating blocks 26 and supported on the metal retainer 253, and a terminal 252 supported on the metal compression spring 251 and partially extended out of the respective locating block 26.

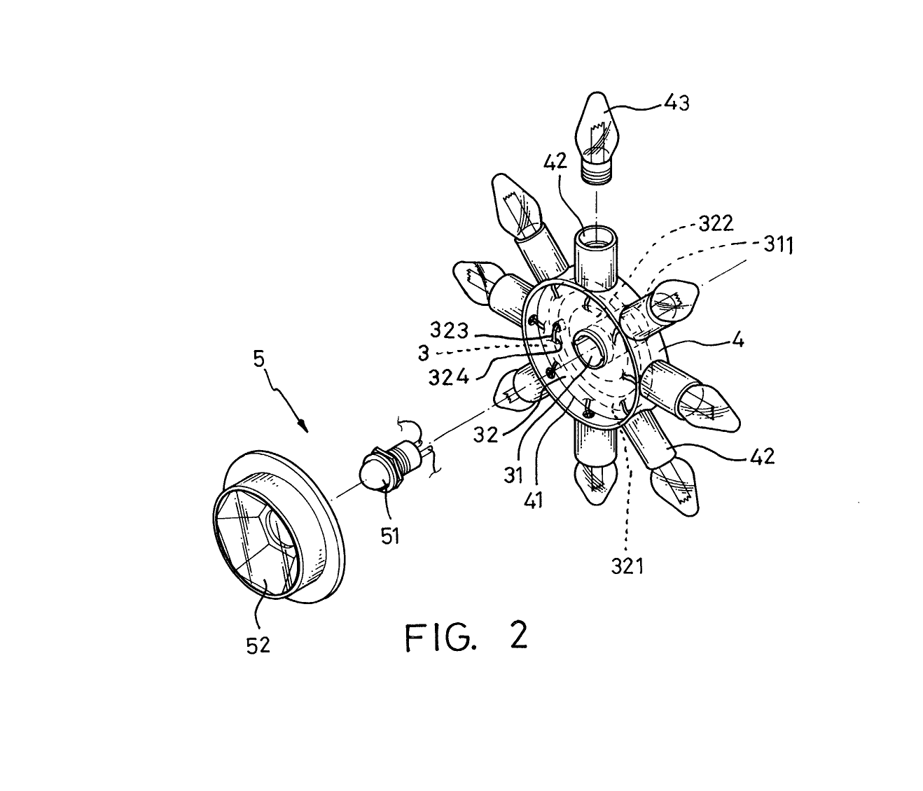

Referring to FIGS. 2 and 3, the revolving power contact unit 3 comprises a tubular revolving shaft 31 coupled to the output shaft 11 of the drive unit 1, the tubular revolving shaft 31 having a coupling slot 311 forced into engagement with the coupling rod 111 of the output shaft 11, an electrically insulative disk 32 mounted on the tubular revolving shaft 31, a first metal contact ring 321 fixedly provided at the back sidewall of the electrically insulative disk 32, a second metal contact ring 322 fixedly provided at the back sidewall of the electrically insulative disk 32 and concentrically disposed around the first metal contact ring 321, and two lead-out wires 323 and 324 respectively welded to the first metal contact ring 321 and the second metal contact ring 322 for output of electric current.

The revolving lamp wheel 4 is a hollow, annular member having a center hole 41, which receives the electrically insulative disk 32 of the revolving power contact unit 3, a plurality of lamp sockets 42 provided around the periphery and electrically connected to the lead-out wires 323 and 324 of the revolving power contact unit 3, and a plurality of lamp bulbs 43 respectively installed in the lamp sockets 42. The lamp bulbs 43 may have two different colors alternatively installed in the lamp sockets 42 around the periphery of the revolving lamp wheel 4. An individual lampshade may be provided and covered over each lamp bulb 43 for protection.

The refractor 5 is provided at the front side of the revolving lamp wheel 4, comprising a lamp bulb 51 mounted in the tubular revolving shaft 31 of the revolving power contact unit 3 at the front side and electrically connected to the lead-out wires 323 and 324 of the revolving power contact unit 3, and a refracting lens 52 covered on the center hole 41 of the revolving lamp wheel 4.

Further, a conical stand 13 is provided to support the motor case 12, a back cover 14 is covered on the motor case 12 over the drive unit 1, and two arched cover plates 15 are covered on the periphery of the motor case 12, keeping the fixed power contact unit 2 from sight.

When electrically connected, the output shaft 11 of the drive unit 1 rotates the tubular revolving shaft 31 of the revolving power contact unit 3, and therefore the revolving power contact unit 3, the revolving lamp wheel 4 and the refractor 5 are rotated with the revolving power contact unit 3. At the same time, electric current is transmitted through the terminals 243 and 244 of the wires 241 and 242 of the power cable 24, the metal contact terminal devices 25 and the first metal contact ring 321 and second metal contact ring 322 of the revolving power contact unit 3 to the lamp bulbs 43 and 51, causing the lamp bulbs 43 and 51 to emit different colors of light when moving with the revolving lamp wheel 4, and therefore a fantastic lighting effect is produced.

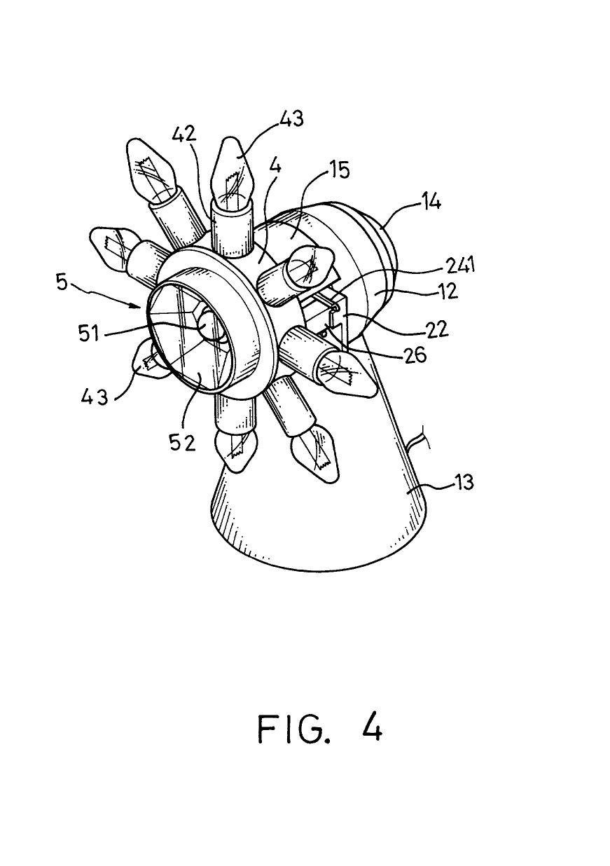

A prototype of revolving stage light has been constructed with the features of FIGS. 1 through 5. The revolving stage light functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A revolving stage light comprising:
a drive unit, said drive unit comprising a motor case, a motor mounted in said motor case, said motor having an output shaft extended out of said motor case;
a fixed power contact unit provided at s front side of said motor case, said fixed power contact unit comprising a base frame, said base frame comprising two seats, said seats each having at least one locating groove, an power cable, said power cable comprising two electric wires respectively fastened to the seats of said base frame, the electric wires of said power cable each having at least one terminal respectively installed in the at least one locating groove of each of said seats, two locating blocks respectively fixedly fastened to said seats of said base frame, said locating blocks each having at least on through hole respectively aimed at the terminals of the electric wires of said power cable at the seats of said base frame, and two metal contact terminal devices mounted in the at least one through hole of each of said locating blocks and maintained in contact with the terminals of the electric wires of said power cable;
a revolving power contact unit, said revolving power contact unit comprising a tubular revolving shaft coupled to the output shaft of the motor of said drive unit, an electrically insulative disk mounted on said tubular revolving shaft, two metal contact rings concentrically fixedly provided at a back sidewall of said electrically insulative disk and respectively disposed in contact with said metal contact terminal devices of said fixed power contact unit, and two lead-out wires respectively welded to said metal contact rings;
a revolving lamp wheel fixedly mounted on said revolving power contact unit, said revolving lamp wheel comprising a center hole, which receives the electrically insulative disk of said revolving power contact unit, a plurality of lamp sockets provided around the periphery thereof and electrically connected to the lead-out wires of said revolving power contact unit, and a plurality of lamp bulbs respectively installed in said lamp sockets.

2. The revolving stage light of claim 1 wherein the output shaft of said motor of said drive unit comprises a coupling rod, and the tubular revolving shaft of said revolving power contact unit comprises a coupling slot forced into engagement with the coupling rod of the output shaft of said motor of said drive unit.

3. The revolving stage light of claim 1 wherein said metal contact terminal devices of said fixed power contact unit each comprise a metal retainer mounted in one through hole of one of said locating blocks and constantly maintained in contact with one terminal of one electric wire of said power cable, a metal spring member mounted in one through hole of one of said locating blocks and supported on said metal retainer, and a terminal supported on said metal spring member and disposed in contact with one metal contact ring of said revolving power contact unit.

4. The revolving stage light of claim I wherein each seat of said base frame of said fixed power contact unit comprises two locating grooves for the positioning of the at least one terminal of the electric wires of said power cable, and said locating blocks each comprises two parallel through holes respectively aimed at the terminals in the locating grooves of said seats of said base frame and adapted to selectively receive said metal contact terminal devices.

5. The revolving stage light of claim 1 further comprising a refractor, said refractor comprising a lamp bulb mounted in the tubular revolving shaft of said revolving power contact unit at a front side and electrically connected to the lead-out wires of said revolving power contact unit, and a refracting lens covered on the center hole of said revolving lamp wheel.

6. The revolving stage light of claim 1 further comprising a stand, which supports said motor case.

7. The revolving stage light of claim 1 wherein the lamp bulbs of said revolving lamp wheel have different colors alternatively mounted in said lamp sockets around the periphery of said revolving lamp wheel.

8. The revolving stage light of claim 1 wherein said revolving lamp wheel further comprises a plurality of lampshades respectively covered over the lamp bulbs of said revolving lamp wheel.
